(19) United States
(12) Patent Application Publication
(10) Pub. No.: US 2026/0276593 A1
(43) Pub. Date: Sep. 17, 2026

(54) EDDY CURRENT (EC) DEFECT VIEW AND DEFECT CLASSIFICATION

(71) Applicant: Evident Canada, Inc., Québec (CA)

(72) Inventors: Rémi Leclerc, Quebec City (CA); Michael Barbeyrol, PONT DE POITTE (FR)

(21) Appl. No.: 19/167,116

(22) PCT Filed: Mar. 28, 2024
(86) PCT No.: PCT/CA2024/050407

§ 371 Date: Sep. 19, 2025

Related U.S. Application Data
(60) Provisional application No. 63/493,190, filed on Mar. 30, 2023.

(51) Int. Cl. G01N 27/90

(52) U.S. Cl. CPC G01N 27/9046; G01N 27/9006

(57) ABSTRACT

A presentation can be generated and displayed indicative of an eddy current (EC) inspection result. For example, an amplitude value or a phase value associated with the eddy current measurement signal can be presented in a graphical manner, such by aligning an indicium of the amplitude value or the phase value with a shape representative of an object under test, the indicium corresponding to a location on or within the shape where the eddy current measurement signal was obtained. In another example, a visual attribute of a displayed indicium of an amplitude value or phase value can be assigned based on a class of defect, such as using different colors corresponding to different defect classes as defined by regions in an impedance plane. Use of attribute to identify defect can be performed either separately, or in combination with alignment of the indicium with the shape.

### CLAIM OF PRIORITY

This patent application claims the benefit of priority of Leclerc et al., U.S. Provisional Patent Application No. 63/493,190, titled “EDDY CURRENT (EC) DEFECT VIEW AND COLOR PALETTE,” filed on Mar. 30, 2023 (Attorney Docket No. 6409.261PRV), which is hereby incorporated by reference herein in its entirety.

### FIELD OF THE DISCLOSURE

This document pertains generally, but not by way of limitation, to apparatus and techniques for non-destructive inspection such as facilitating eddy current inspection, and more particularly, to apparatus and techniques for generating a presentation of an inspection result in manner that provides classification of defects, such as by color, or an indication of a spatial location of a defect on a representation of the object under test, or combinations of such classification and spatial location indication.

### BACKGROUND

Non-destructive testing (NDT) can refer to use of one or more different techniques to inspect regions on or within an object, such as to ascertain whether flaws or defects exist, or to otherwise characterize the object being inspected. One class of non-destructive testing can include use of an eddy current testing approach where electromagnetic energy is applied to the object and resulting induced currents on or within the object are detected, with the values of a detected current (or a related impedance) providing an indication of the structure of the object under test, such as to indicate a presence of a crack, scratch, void, porosity, or other inhomogeneity. Generally, an eddy current (EC) sensor includes one or more sensor elements such as inductive coils that can be excited using an alternating current (AC) source. Such coils (or other electromagnetic sensing elements such as hall sensors) can be used for receiving a signal indicative of an induced eddy current on or within the structure. As an illustration, an eddy current probe can be inserted in a hole, such as a bolt hole, and the eddy current probe can be rotated within the hole or otherwise excited to provide circumferential inspection coverage around a circumference of the hole.

### SUMMARY OF THE DISCLOSURE

Eddy current (EC) testing is a versatile non-destructive inspection technique. As illustrative examples, EC inspection can be used to identify corrosion, pitting, cracks, or other defects in conductive structures. In one application, an eddy current probe can be used to inspect a circumference of a hole in a conductive structure. Such inspection can be used to identify defects such as burrs, scratches, cracks, or voids located along a circumference of the hole, such as defects on or within the inside-facing wall of the hole. Such inspection can be referred to generally as EC “bolt hole” inspection. In one approach, EC inspection results for hole inspection can be visualized using strip-chart or impedance plane views. Strip-chart indications (e.g., a “waterfall” plot) or impedance plane indications can reliably flag a presence of a defect. However, the present inventors have recognized that such visualizations generally lack cues to a user as to an actual spatial location of such a defect.

In an example, the present subject matter can be used to generate or provide one or more graphical indicia to a user indicative of an eddy current (EC) inspection result. For example, an indication of a defect location or other feature can be presented graphically in relation to a graphical representation of the region being inspected. For example, a circular (two-dimensional) or cylindrical (three-dimensional) presentation can be established where a defect angular position or indicium of a magnitude of an eddy current signal indication, such as corresponding to an approximation of defect depth in the material, or both, are shown by an indication aligned with the circular or cylindrical presentation. An estimate or measurement of axial location of the defect can also be indicated. In this manner, a user viewing the presentation can more easily pinpoint (e.g., localize) a physical location on or within an object under test, corresponding to a displayed indication.

In another example, an indication of a defect or other feature can include a classification established or selected based on a type of defect, such as at least in part using phase and amplitude criteria applied to a complex-valued signal representation acquired from an EC inspection probe. As an illustration, such classification can be indicated by a color (or other visual attribute). As mentioned above, a defect indication can be arranged spatially on a representation of the object under test corresponding to a physical location of the feature that generated the indication. Such a presentation providing a visualization of a location of a defect can be combined with a color-coded representation of a defect classification. Color is merely an illustrative example of an attribute that can indicate a defect class, and another attribute of a graphical indication can be adjusted to provide information about defect classification (e.g., one or more of adjustment of hue, saturation, luminance, symbol, or size of a graphical indication). Attributes can also be contemporaneously provided indicative of other parameters such as eddy current measurement signal amplitude, such as by modulating an attribute (e.g., enhancing or decreasing brightness or saturation of a color-coded defect based on indication amplitude).

In an example, a machine-implemented method can include generating an eddy current excitation signal to excite a sensor of an inspection probe assembly, receiving an eddy current measurement signal from the inspection probe assembly, determining at least one of an amplitude value or a phase value associated with the eddy current measurement signal, and generating a presentation (such as for display to a user) indicative of the amplitude value or the phase value including aligning an indicium of the amplitude value or the phase value with a shape representative of an object under test, the indicium corresponding to a location on or within the shape where the eddy current measurement signal was obtained. The machine-implemented method can include assigning a visual attribute of the indicium based on a class of defect.

In an example, a machine-implemented method can include generating an eddy current excitation signal to excite a sensor of an inspection probe assembly, receiving an eddy current measurement signal from the inspection probe assembly, determining at least one of an amplitude value or a phase value associated with the eddy current measurement signal, and generating a presentation for display to a user indicative of the amplitude value or the phase value including assigning a visual attribute of an indicium of the amplitude value or the phase value based on a class of defect, where the visual attribute comprises at least one of a brightness, a hue, a saturation, or a pattern corresponding to a respective class of defect.

In an example, the machine-implemented methods mentioned above or as described elsewhere herein can be performed using a system comprising a transmitter circuit to generate an eddy current excitation signal to excite a sensor of an inspection probe assembly, a receiver circuit to receive an eddy current measurement signal from the inspection probe assembly, a processor circuit, and a memory circuit coupled to the processor circuit, the memory circuit comprising instructions that, when executed by the processor circuit, cause the system to perform a machine-implemented method mentioned above or as described elsewhere herein.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising a non-destructive inspection system, such as can be used to perform at least a portion one or more techniques as shown and described herein.

FIG. 2 illustrates generally an example comprising an eddy current inspection probe scanner and associated sensor, such as for bolt hole inspection.

FIG. 3A and FIG. 3B show illustrative examples of plots representative of acquired eddy current measurement signals, with FIG. 3A showing an amplitude of a signal component versus time, and FIG. 3B showing amplitudes of two respective signal components plotted parametrically.

FIG. 3C shows an illustrative example of a series of plots representative of acquired eddy current measurement signals representing an amplitude of a signal component versus time.

FIG. 4A shows an illustrative example of a presentation comprising a two-dimensional representation of a shape of an object under test and an associated indicium of an eddy current measurement signal.

FIG. 4B shows an illustrative example of a presentation comprising a three-dimensional representation of a shape of an object under test and an associated indicium of an eddy current measurement signal.

FIG. 5A shows an illustrative example of a plot representative of an acquired eddy current measurement signal plotted parametrically, and alarm regions corresponding to different classes of defects.

FIG. 5B shows an illustrative example of a presentation comprising plots showing acquired eddy current measurement signals and associated indicia of defects that can be identified using the alarm regions shown in FIG. 5A.

FIG. 6 shows an illustrative example of a presentation comprising plots showing an acquired eddy current measurement signal and associated indicia of defects that can be identified using an alarm region, such as for measurement applications other than bolt hole inspection.

FIG. 7 illustrates generally a technique, such as a machine-implemented method comprising generating a presentation for display to a user indicative of an amplitude value or a phase value from an eddy current measurement signal including aligning an indicium of the amplitude value or the phase value with a shape representative of an object under test.

FIG. 8 illustrates generally a technique, such as a machine-implemented method comprising generating a presentation for display to a user indicative of an amplitude value or a phase value from an eddy current measurement signal including assigning a visual attribute of a displayed indicium based on a class of defect.

FIG. 9 illustrates a block diagram of an example comprising a machine upon which any one or more of the techniques (e.g., methodologies) discussed herein may be performed.

### DETAILED DESCRIPTION

The subject matter described in this document can facilitate eddy current (EC) testing, such as providing presentations for a graphical user interface (GUI) and related machine-implemented tools to aid a user in localizing or classifying (or both localizing and classifying) defects indicated by EC measurements. For example, the present subject matter can include generating a defect visualization presentation, such as providing indicia of detected defects overlaid on a visualization of at least a portion of the object under test.

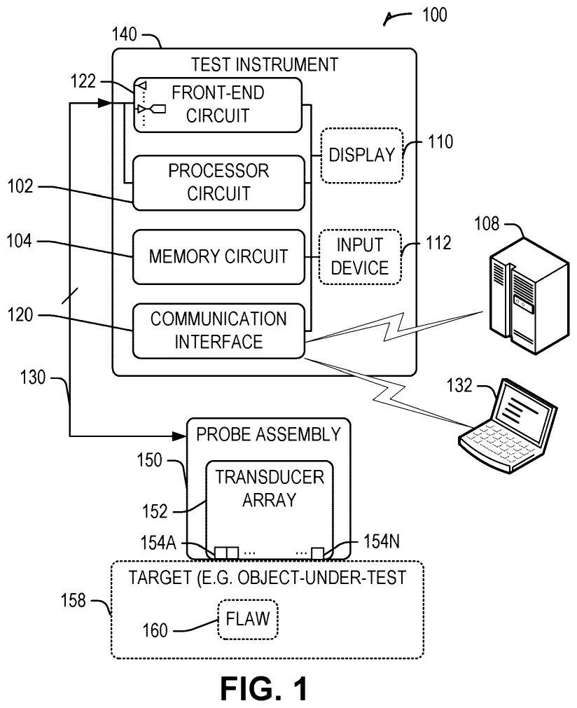

FIG. 1 illustrates generally an example comprising a non-destructive inspection system 100, such as can be used to perform at least a portion one or more techniques as shown and described herein. The non-destructive inspection system 100 can include a test instrument 140, such as a hand-held or portable assembly. The test instrument 140 can be electrically coupled to a probe assembly 150, such as using a multi-conductor interconnect 130. The probe assembly 150 can include one or more eddy coil sensors, such as an eddy current (EC) sensor array 152 including respective EC sensors 154A through 154N.

A modular probe assembly 150 configuration can be used, such as to allow a test instrument 140 to be used with various different probe assemblies. Generally, the sensor array 152 includes EC coils, such as located on or within a substrate. The EC coils are electromagnetically coupled with a target 158 (e.g., a test specimen or “object-under-test”). The test instrument 140 can include digital and analog circuitry, such as a front-end circuit 122 including one or more transmit signal chains (forming a transmitter circuit), receive signal chains (forming a receiver circuit), or switching circuitry (e.g., transmit/receive switching circuitry). The transmit signal chain can include amplifier and filter circuitry, such as to provide an alternating current (AC) excitation signal for delivery through an interconnect 130 to a probe assembly 150. A flaw 160 associated with the target 158 can be detected such as by monitoring an impedance or other electrical characteristic associated with respective sensors 154A through 154N in the sensor array 152, such as by digitizing an eddy current measurement signal elicited in response to the excitation signal.

A test protocol can be performed using coordination between multiple test instruments 140, such as in response to an overall test scheme established from a respective test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples. Generally, as described elsewhere herein, an EC inspection configuration can be established separately, such as executed by a test instrument 140 in a fully automated or semi-automated manner.

The front-end circuit 122 can be coupled to and controlled by one or more processor circuits, such as a processor circuit 102 included as a portion of the test instrument 140. The processor circuit can be coupled to a memory circuit 104, such as to execute instructions that cause the test instrument 140 to perform one or more of EC inspection, processing, or storage of data relating to an EC inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. The test instrument 140 can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries. In an illustrative example, the probe assembly 150 can include a hole probe

sensor, such as configured to be plunged within a hole (e.g., a bolt hole) and rotated either manually or using a rotary actuator (e.g., a bolt hole scanner). A location of the probe assembly 150 within the hole (e.g., in an axial direction) can be measured manually, such as using a scale or indicator included as a portion of the probe assembly 150, or the probe assembly 150 can be coupled with an encoder to log or indicate an axial location value. For example

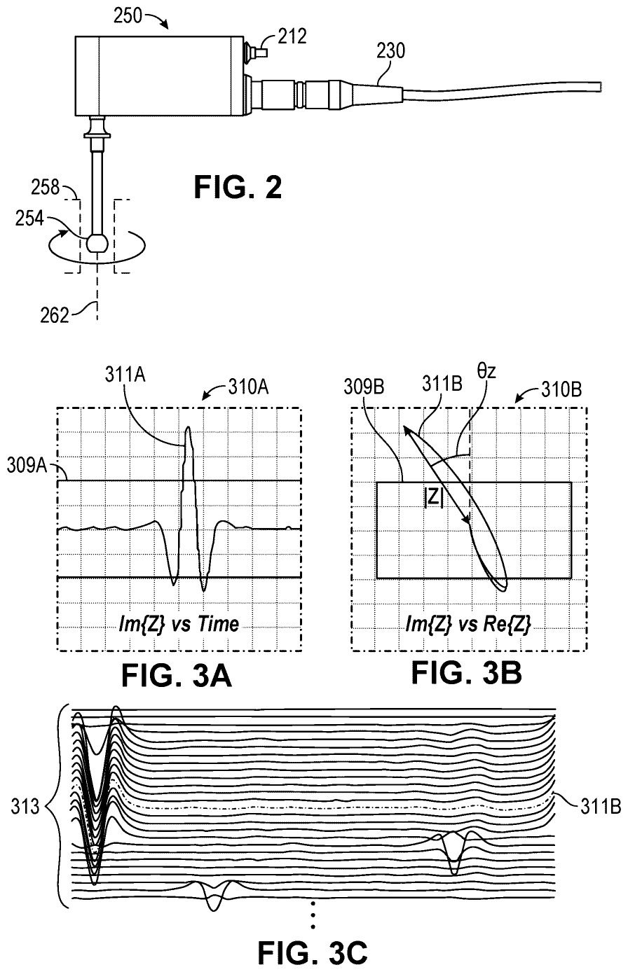

FIG. 2 illustrates generally an example comprising an eddy current inspection probe scanner 250, such as for bolt hole inspection. Generally, the eddy current inspection probe scanner 250 is coupled with a probe assembly comprising a sensor 254 (e.g., a coil). The probe assembly can be rotated by the scanner 250, such as detachable from the scanner 250 (e.g., so that multiple different probe assemblies can be used with the scanner 250 depending on application). A multi-conductor interconnect 230 to provide an interface between the eddy current inspection probe scanner 250 and a measurement instrument, as discussed above. In the illustrative example of FIG. 2, the eddy current inspection probe scanner 250 can include an actuator such as a motor to rotate the sensor 254 to provide circumferential coverage of an interior of a hole 258 in an object under test, such as for performing bolt hole inspection. The probe can be translated in an axial direction 262 so that the rotating sensor 254 covers an entirety or desired portion of the interior of the hole 258. The eddy current inspection probe scanner 250 need not include automatic rotation and could instead carry a probe that is translated and rotated entirely by hand. One or more encoders can be used, such as to correlate an acquired eddy current measurement signal with one or more of an angular position of rotation of the sensor 254 or an axial position of the sensor 254. The examples in this document are generally applicable to bolt hole inspection but are also applicable to other eddy current inspection applications as discussed below.

FIG. 3A and FIG. 3B show illustrative examples of plots representative of acquired eddy current measurement signals, with FIG. 3A showing an amplitude of a signal component versus time, and FIG. 3B showing amplitudes of two respective signal components plotted parametrically. FIG. 3A can be referred to as a strip-chart 310A view, where the amplitude corresponds to an imaginary part of a complex-valued eddy current measurement signal (e.g., an imaginary part of an impedance signal). Generally, an indication 311A in the strip-chart 310A that exceeds a threshold 309A in either a positive-going or negative-going direct can indicate a presence of a defect in an object under test. As discussed above, such a strip-chart 310A view does not provide an intuitive (or even any) spatial guide to an operator as to a physical location along an object under test corresponding to the feature that resulted in the indication 311A. Another visualization of an eddy current measurement signal is shown in FIG. 3B, where an impedance plane 310B view shows a parametric plot of a real part and an imaginary part of an eddy current measurement signal. The impedance plane 310B can provide additional information concerning a defect, such as where an indication 311B extends outside a box 309B defining an alarm or limit boundary. As an illustration, qualitative or semi-quantitative alarm criteria can be applied to distinguish between defect classes in a bolt-hole inspection application:

TABLE I
Semi-quantitative classification criteria for
Impedance Plane EC Acquisition

| EXAMPLE OF | PHASE SHIFT | |
|---|---|---|
| DEFECT | DIRECTION RELATIVE | AMPLITUDE |
| CLASS | TO VERTICAL (θz) | (\|Z\|) |
| Fatigue crack | To the right | >25% SH |
| Fatigue crack | To the left | >75% SH |
| Scratches | To the left <45° | <40-50% SH |
| Nick/Gouge | To the left 45° | <40-50% SH |
| Ding | To the left 45° | <20% SH |
| Corrosion | To the left with no clear | 30-40% SH |
| | signal on sweep mode | |

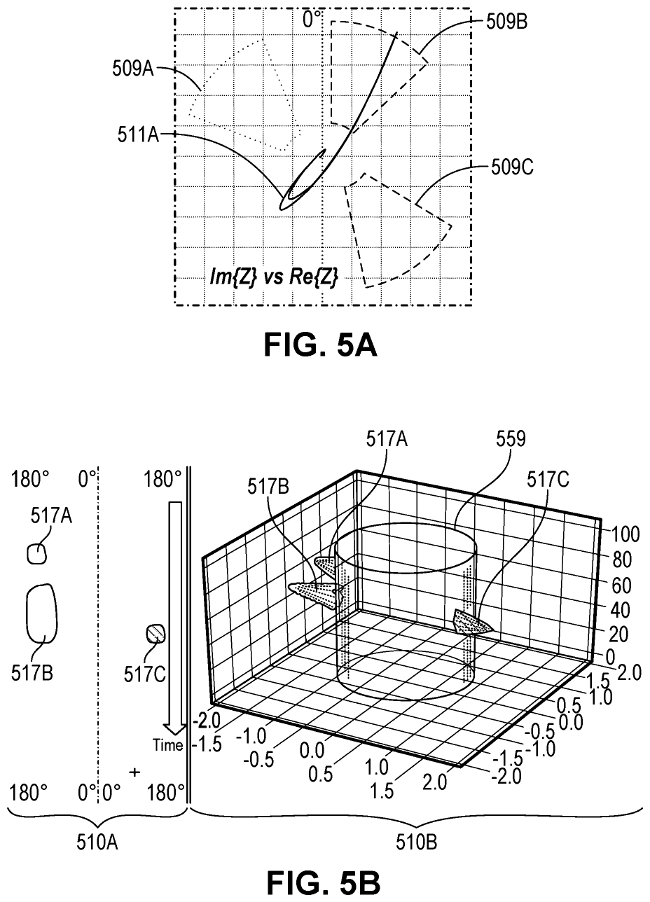

The criteria shown above in TABLE I can correspond to different segments or “sectors” in an impedance plane and can be referred to as “sectorial” alarms, due to the sector-like shape of such alarm regions when overlaid on an impedance plane view. Color or other attributes can be associated with respective alarms as discussed below in relation to FIG. 5A. Referring back to FIG. 3B, in the impedance plane 310B view, no indication is provided as to a physical location of a feature or flaw leading to the indication 311A. In yet another example, a “waterfall” view of a series of successive eddy current measurement acquisitions can be displayed, such as shown in FIG. 3C.

FIG. 3C shows an illustrative example of a series 313 of plots representative of acquired eddy current measurement signals representing an amplitude of a signal component versus time. For example, as discussed above in relation to FIG. 2, each strip-chart trace shown in the series 313 can correspond to a 360-degree rotation of a sensor about a circumference of a hole in an object under test. As the eddy current inspection probe is moved axially through the hole, each strip-chart trace can correspond to a different axial position. Even with such an indication of axial position, the series 313 does not intuitively indicate a physical location of a flaw to a user, so interpretation of such a view can present a challenge.

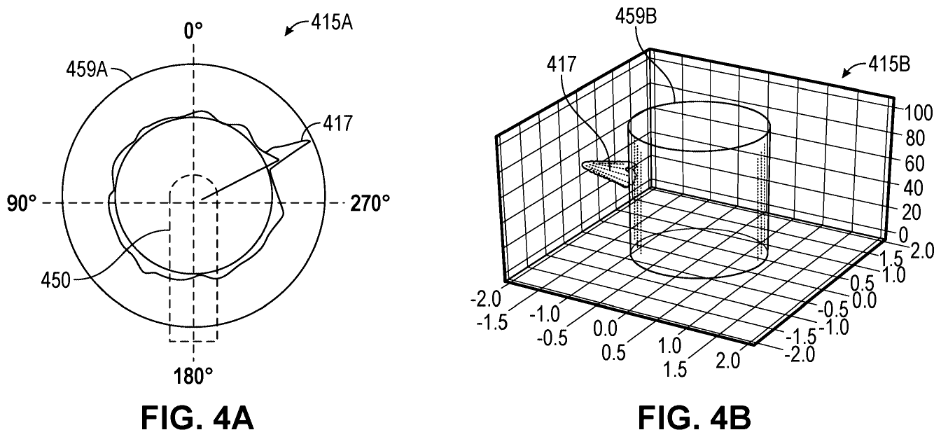

The present inventors have recognized, among other things, that a strip-chart time-series can be wrapped around a representation of a shape of an object under test. For example, FIG. 4A shows an illustrative example of a presentation 415A comprising a two-dimensional representation 459A of a circular shape of an object under test and an associated indicium 417 of an eddy current measurement signal. The eddy current measurement signal can be a continuous strip-chart trace (such as interpolated between individual acquired data points) or a series of individual indicia such as dots or other symbols. A representation of the signal can be wrapped around the two-dimensional representation 459A to show a relative or absolute angular position of flaws or other detected features along a circumference of a hole or other structure, corresponding to a location where the eddy current measurement signal (or a portion thereof) was obtained. To aid in interpretation, a “ghost” outline or other indicium of the eddy current inspection probe scanner 450 position can be overlaid on the presentation 415A. For example, the eddy current inspection probe scanner 450 can be fixed such as indicating a zero-degree datum relative to which the other information is overlaid.

In a manner similar to FIG. 4A, FIG. 4B shows an illustrative example of a presentation 415B comprising a three-dimensional representation 459B of a shape of an object under test and an associated indicium 417 of an eddy current measurement signal. The three-dimensional representation 459B can represent an interior wall of a bolt hole or other structure, and a series of acquired strip-chart time-series eddy current measurement signals can be wrapped around the three-dimensional representation 459B to visualize physical locations corresponding to the acquired eddy current measurement signal indications. An axial location of an indication of the three-dimensional representation 459B can be established such as by using data from an encoder that provides depth information in an axial direction. In another approach, the axial position of the indicium 417 along the three-dimensional representation 459B can be established such that each axial location corresponds to one 360-degree revolution of a scanner, and a count of such revolutions corresponds to the axial location where the indicium 417 is generated. In this approach, the absolute position of the indicium 417 is not known, but the axial location is approximated by the count. A depth of protrusion of a defect corresponding to indicium 417 may not be known, but an approximation of defect penetration into the object under test or defect severity can be indicated such as using a length or other visual representation of indicium 417. For example, the indicium can penetrate further outward radially from the three-dimensional representation 459B in proportion to a magnitude of a vertical (e.g., imaginary) part of an impedance plane representation corresponding to the indicium.

The three-dimensional representation 459B can be partially transparent or may be rotated in response to an input from a user, to visualize indications that may be obscured by the cylindrical representation. In the examples of FIG. 4A and FIG. 4B, the strip-chart representation can be representative of an envelope of an acquired eddy current measurement signal, a raw signal, or a rectified representation of such a signal, as illustrative examples. For example, the strip-chart representations that are wrapped around a shape can represent an imaginary part of an acquired eddy current measurement signal.

One or more “alarm” criteria can be used to determine whether and how to represent the associated indicium 417 on the three-dimensional representation 459B. For example, a threshold or range window can be established as discussed in other examples herein. As discussed below in relation to FIG. 5B, different classes of defects can be represented by unique attributes, such as to provide indica having different color (e.g., hue), saturation, brightness, or shading (e.g., patterns or symbols, such as including hatching).

FIG. 5A shows an illustrative example of a plot representative of an acquired eddy current measurement signal 511A from a bolt hole inspection, plotted parametrically, and alarm regions 509A, 509B, and 509C corresponding to different classes of defects. Because the regions define areas in the impedance plane in this example, such regions represent a combination of phase and amplitude criteria (e.g., range criteria defining a combination of an amplitude range and a phase range). For example, if an acquired eddy current measurement signal 511A enters alarm region 509A, a scratch may be indicated. If the acquired eddy current measurement signal 511A enters the alarm region 509B (as shown in FIG. 5A), a fatigue crack may be indicated, and if the acquired eddy current measurement signal 511A enters the alarm region 509C, a burr may be present. Each of the alarm regions 509A, 509B, and 509C can be assigned to a different color or have another attribute assigned, so that a classification of suspected defects can be indicated visually to a user either using different colors or other display attributes such as different brightness, or different visual patterns (e.g., hatching or symbols).

Such defect classification using the alarm regions 509A, 509B, and 509C can be visualized in a variety of different manners. For example, FIG. 5B shows an illustrative example of a presentation showing acquired eddy current measurement signals and associated indicia of defects that can be identified using the alarm regions shown in FIG. 5A. A water-fall-like presentation can be generated such as appearing as shown in the region 510A in FIG. 5B, where two defect indicia 517A and 517B are shown as having a first attribute (e.g., red color) corresponding to their respective eddy current traces entering the region 509B in FIG. 5A, and another defect indicium 517C is shown as having a different second attribute (e.g., blue color) because corresponding eddy current traces entered region 509A of FIG. 5A. Similarly, the defect indicia 517A, 517B, and 517C can be overlaid on a representation of a shape of a three-dimensional representation 559 of a shape of an object under test in the region 510B of FIG. 5B, in a manner similar to the discussion above in relation to FIG. 4B. Multiple attributes can be varied in the presentation in response to a combination of defect classification and other parameters, such as acquired eddy current measurement signal amplitude. For example, a color could be used to indicate a defect class, and a brightness (e.g., intensity) or color saturation in the presented indicia could indicate eddy current measurement signal amplitude. In an example, a user can adjust one or more of phase, amplitude, or other criteria, or adjust classification indicia such as color or another attribute.

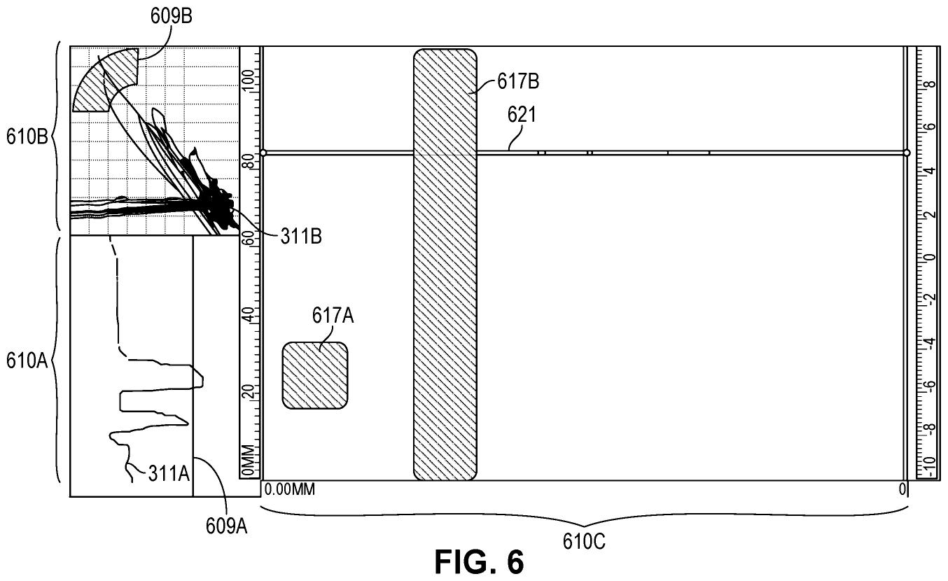

In the examples discussed above, a criterion used for defect classification can be related to a specific measurement application and material classification (e.g., bolt hole inspection in ferrous material). However, the visualization and defect classification techniques described herein are applicable to other eddy current inspection applications, such as low-frequency eddy current (LFEC) and high-frequency eddy current (HFEC) inspection, such as using an individual EC sensor or an eddy current array (ECA) probe. For example, FIG. 6 shows an illustrative example of a presentation plots showing a strip-chart 310A representation of an acquired eddy current measurement signal in the region 610A with an alarm threshold defined by the line 609A, along with an impedance plane 310B representation of the acquired eddy current measurement signal in the region 610B with a defect criterion defined by alarm region 609B, and a C-scan representation shown in the region 610C, with defects classified by indicia 617A and 617B, and a line 621 indicating a selected location corresponding to the presented strip-chart representation in region 610A and impedance plane representation in region 610B. As in the examples above, multiple alarm regions can be defined corresponding to different classes of defects, and an attribute (e.g., color) of the displayed indicia 617A and 617B can be assigned based on a defect classification.

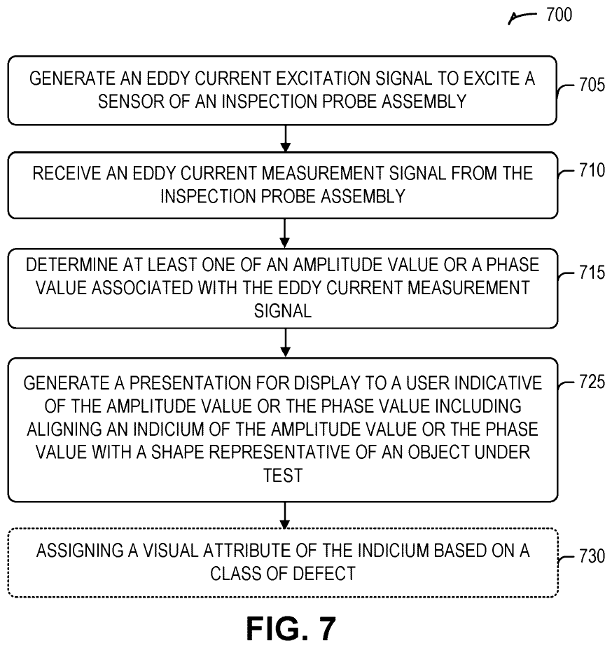

FIG. 7 illustrates generally a technique 700, such as a machine-implemented method comprising generating a presentation for display to a user indicative of an amplitude value or a phase value from an eddy current measurement signal including aligning an indicium of the amplitude value or the phase value with a shape representative of an object under test. At 705, an eddy current excitation signal can be generated, such as for excitation of a coil or other sensor of an inspection probe assembly. At 710, in response, an eddy current measurement signal can be received from the inspection probe assembly. Such a measurement signal can include a rectified signal or other signal representative of an envelope of a received alternating current (AC) measurement signal, or other representation such as a raw signal or an amplitude time-series representing an imaginary part of a complex-valued digitized signal, as illustrative (but non-limiting) examples. At 715, an amplitude value or a phase value (or both) associated with the eddy current signal can be determined. For example, as shown and described above, a series of respective values can be represented as a time-series or in a parametric manner such as represented in an impedance plane. At 725, a presentation can be generated for display to a user, the presentation indicative of the determined amplitude value or phase value (or a series of such values), such as aligning an indicium of the amplitude value or phase value (or a series of such values) with a shape representative of an object under test, as discussed above. In this manner, a defect indication in an acquired eddy current signal can be visualized in a manner indicative of a location where the signal was obtained to assist a user in physically localizing a defect. Optionally, at 730, a visual attribute of the indicium (such as hue, brightness, saturation) can be assigned based a class of defect, as discussed elsewhere in this document.

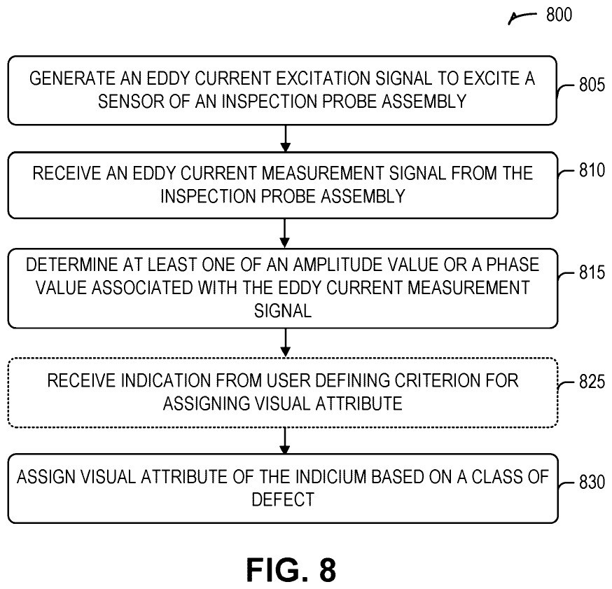

FIG. 8 illustrates generally a technique 800, such as a machine-implemented method comprising generating a presentation for display to a user indicative of an amplitude value or a phase value from an eddy current measurement signal including assigning a visual attribute of a displayed indicium based on a class of defect. At 805, an eddy current excitation signal can be generated, such as for excitation of a coil or other sensor of an inspection probe assembly. At 810, in response, an eddy current measurement signal can be received from the inspection probe assembly. Such a measurement signal can include a rectified signal or other signal representative of an envelope of a received alternating current (AC) measurement signal, or other representation such as a raw signal or an amplitude time-series representing an imaginary part of a complex-valued digitized signal, as illustrative (but non-limiting) examples. At 815, an amplitude value or a phase value (or both) associated with the eddy current signal can be determined. For example, as shown and described above, a series of respective values can be represented as a time-series or in a parametric manner such as represented in an impedance plane. At 830, a visual attribute of an indicium to be presented to a user can be assigned based on a class of defect. For example, such defect classification can be based on application of a range criterion or other criteria to an acquired eddy current measurement signal as shown and described above (e.g., a sectorial alarm region or one or more numerical ranges defined by amplitude or phase values, or combinations of amplitude and phase values). At 825, optionally, a user can provide an indication defining a criterion for assigning a visual attribute of an indicium based on a specified defect classification, or such definitions can be retrieved based on a specified or select eddy current measurement application (e.g., bolt hole inspection versus other inspection) or material under test (e.g., ferrous vs non-ferrous).

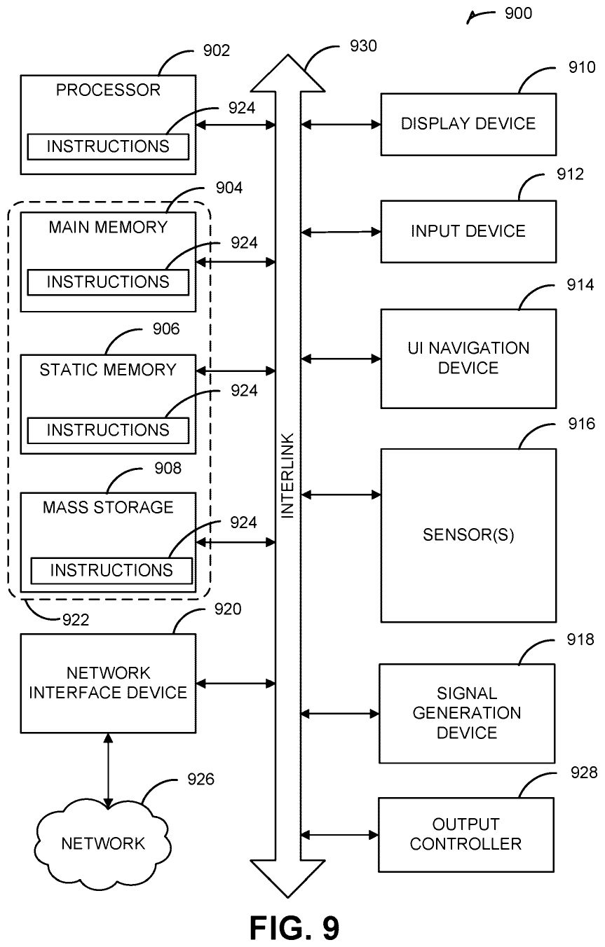

FIG. 9 illustrates a block diagram of an example comprising a machine 900 upon which any one or more of the techniques (e.g., methodologies) discussed herein may be performed. Machine 900 (e.g., computer system) may include a hardware processor 902 (e.g., a central processing unit (CPU), a graphics processing unit (GPU), a hardware processor core, or any combination thereof), a main memory 904 and a static memory 906, connected via an interlink 930 (e.g., link or bus), as some or all of these components may constitute hardware for systems or related implementations discussed above.

Generally, the hardware processor 902 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor circuit may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor, as a virtual processor or virtual circuit. The virtual processor may behave like an independent processor but is implemented in software rather than hardware.

Specific examples of main memory 904 include Random Access Memory (RAM), and semiconductor memory devices, which may include storage locations in semiconductors such as registers. Specific examples of static memory 906 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 900 may further include a display device 910, an input device 912 (e.g., a keyboard), and a user interface (UI) navigation device 914 (e.g., a mouse). In an example, the display device 910, input device 912, and UI navigation device 914 may be a touch-screen display. The machine 900 may include a mass storage device 908 (e.g., drive unit), a signal generation device 918 (e.g., a speaker), a network interface device 920, and one or more sensors 916, such as a global positioning system (GPS) sensor, compass, accelerometer, or some other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 908 may comprise a machine-readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the mass storage device 908 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 924.

An apparatus of the machine 900 includes one or more of a hardware processor 902 (e.g., a central processing unit (CPU), a graphics processing unit (GPU), a hardware processor core, or any combination thereof), a main memory 904 and a static memory 906, sensors 916, network interface device 920, antennas, a display device 910, an input device 912, a UI navigation device 914, a mass storage device 908, instructions 924, a signal generation device 918, or an output controller 928. The apparatus may be configured to perform one or more of the methods or operations disclosed herein.

The term “machine readable medium” includes, for example, any medium that is capable of storing, encoding, or carrying instructions for execution by the machine 900 and that cause the machine 900 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 924 may be transmitted or received, for example, over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 920 includes one or more physical jacks (e.g., Ethernet, coaxial, or other interconnection) or one or more antennas to access the communications network 926. In an example, the network interface device 920 includes one or more antennas to wirelessly communicate using at least one of single-input multiple-output (SIMO), multiple-input multiple-output (MIMO), or multiple-input single-output (MISO) techniques. In some examples, the network interface device 920 wirelessly communicates using Multiple User MIMO techniques. The term “transmission medium” shall be taken to include any intangible medium that is capable of storing, encoding or carrying instructions for execution by the machine 900, and includes digital or analog communications signals or other intangible medium to facilitate communication of such software.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A machine-implemented method, comprising:
generating an eddy current excitation signal to excite a sensor of an inspection probe assembly;
receiving an eddy current measurement signal from the inspection probe assembly;
determining at least one of an amplitude value or a phase value associated with the eddy current measurement signal; and
generating a presentation for display indicative of the amplitude value or the phase value including aligning an indicium of the amplitude value or the phase value with a shape representative of an object under test.

2. The machine-implemented method of claim 1, comprising assigning a visual attribute of the indicium based on a class of defect.

3. The machine-implemented method of claim 2, comprising receiving an indication from a user defining a criterion for assigning the visual attribute.

4. The machine-implemented method of claim 3, wherein the criterion for assigning the visual attribute comprises a range criterion.

5. The machine-implemented method of claim 3, wherein the criterion is indicated or defined graphically.

6. The machine-implemented method of claim 5, wherein the criterion is indicated or defined graphically on a coordinate system having a real part and an imaginary part corresponding to an impedance plane plot of the eddy current measurement signal.

7. The machine-implemented method of claim 4, wherein the range criterion is amongst different respective criteria corresponding to different classes of defects.

8. The machine-implemented method of claim 2, wherein the visual attribute comprises at least one of a brightness, a hue, a saturation, or a pattern corresponding to a respective class of defect.

9. The machine-implemented method of claim 1, wherein the presentation comprises a two-dimensional presentation comprising a circular shape; and
wherein a series of indicia of amplitude values or phase values are indicated at different angular positions about the circular shape, the series of indicia corresponding to eddy current measurement signals obtained at the different angular positions.

10. The machine-implemented method of claim 1, wherein the presentation comprises a three-dimensional presentation comprising a cylindrical shape; and
wherein a series of indicia of amplitude values or phase values are indicated at different angular and axial positions about the cylindrical shape, the series of indicia corresponding to eddy current measurement signals obtained at the different angular and axial positions.

11. The machine-implemented method of claim 10, wherein the series of values corresponds to at least one axial location measured by an encoder.

12. The machine-implemented method of claim 11, wherein a angular location of a scanner body or other portion of the inspection probe assembly is indicated in combination with the series of indicia of amplitude values or phase values.

13. The machine-implemented method of claim 11, wherein the series of indicia comprise amplitudes of an imaginary signal component from a complex-valued eddy current measurement signal; and
wherein the different angular positions around a circumference of a circular or a cylindrical shape comprise different angular positions of a bolt hole defined by the object under test.

14-19. (canceled)

20. A system comprising:
a transmitter circuit to generate an eddy current excitation signal to excite a sensor of an inspection probe assembly;
a receiver circuit to receive an eddy current measurement signal from the inspection probe assembly;
a processor circuit; and
a memory circuit coupled to the processor circuit;
wherein the memory circuit comprises instructions that, when executed by the processor circuit, cause the system to:
generate an eddy current excitation signal to excite a sensor of an inspection probe assembly;
receive an eddy current measurement signal from the inspection probe assembly;
determine at least one of an amplitude value or a phase value associated with the eddy current measurement signal; and
generate a presentation for display indicative of the amplitude value or the phase value including aligning an indicium of the amplitude value or the phase value with a shape representative of an object under test.

21. The system of claim 20, wherein the memory circuit comprises instructions to assign a visual attribute of the indicium based on a class of defect.

22. The system of claim 21, wherein a criterion for assigning the visual attribute comprises a range criterion.

23. The system of claim 22, wherein the criterion is indicated or defined graphically.

24. The system of claim 23, wherein the criterion is indicated or defined graphically on a coordinate system having a real part and an imaginary part corresponding to an impedance plane plot of the eddy current measurement signal.

25. The system of claim 22, wherein the range criterion is amongst different respective criteria corresponding to different classes of defects.

26. The system of claim 22, wherein the visual attribute comprises at least one of a brightness, a hue, a saturation, or a pattern corresponding to a respective class of defect.
